(19) United States
(12) Patent Application Publication
(10) Pub. No.: US 2026/0266189 A1
(43) Pub. Date: Sep. 10, 2026

(54) STATOR ASSEMBLY FOR AN AIRCRAFT TURBINE ENGINE

(71) Applicant: SAFRAN AIRCRAFT ENGINES, PARIS (FR)

(72) Inventors: Julian Nicolas GIRARDEAU, MOISSY-CRAMAYEL (FR); Laurent Cédric ZAMAI, MOISSY-CRAMAYEL (FR); Sylvain Romain Réal BRAULT, MOISSY-CRAMAYEL (FR); Benoit Guillaume SILET, MOISSY-CRAMAYEL (FR)

(21) Appl. No.: 19/165,794

(22) PCT Filed: Mar. 22, 2024
(86) PCT No.: PCT/FR2024/050363

§ 371 Date: Sep. 16, 2025

(30) Foreign Application Priority Data
Mar. 23, 2023 (FR) 2302780

(51) Int. Cl. F01D 11/02

(52) U.S. Cl. CPC F01D 11/02; F05D 2220/323

(57) ABSTRACT

A seal for an aircraft turbine engine includes a plurality of seal segments that are circumferentially distributed about a longitudinal axis. Each seal segment has a radially outer annular wall segment and a radially inner annular wall segment which are connected to each other by an elastically deformable member. The radially outer annular wall segments form a monolithic outer shroud, and the radially inner annular wall segments are arranged circumferentially end-to-end. Each radially inner annular wall segment has a first circumferential edge and an opposite second circumferential edge which each has a slit. A tongue is mounted in part at the junction of two facing circumferential edges.

### CROSS-REFERENCE TO RELATED APPLICATIONS

This application is a U.S. National phase entry of International Application No. PCT/FR2024/050363 filed Mar. 22, 2024, which claims priority to French Patent Application No. 2302780 filed Mar. 23, 2023, both of which are hereby incorporated by reference in their entirety.

### TECHNICAL FIELD

The present invention relates to an annular seal, such as a hydrostatic annular seal. The present document also relates to an assembly comprising such a seal as well as a turbine or a turbine engine comprising such a seal.

Background FIG. 1 schematically shows a turbine engine 1 with a longitudinal axis X. The turbine engine 1 generally comprises, from upstream AM to downstream AV in the direction of flow of the gases within the turbine engine 1, a fan 2, a low-pressure compressor 3, a high-pressure compressor 4, a combustion chamber 5, a high-pressure turbine 6, a low-pressure turbine 7 and an exhaust system downstream of the turbine engine 1. The flow of gas, in particular air, entering upstream of the turbine engine 1 first of all flows through the fan 2 and then divides, on the one hand, into an annular flow path referred to as the core flow 8, and on the other hand, into an annular flow path referred to as the bypass flow 9 surrounding the core flow 8. The low-pressure compressor 3, the high-pressure compressor 4, the combustion chamber 5, the high-pressure turbine 6 and the low-pressure turbine 7 are arranged in the core flow 8.

In the present document, the terms “longitudinal”, “radial” and “circumferential” are defined with respect to the longitudinal axis X of the turbine engine 1, the longitudinal axis X coinciding with the axis of rotation of the low-pressure and high-pressure rotors of the turbine engine 1. The terms “inside” and “outside”, as well as “internal” and “external”, are then defined in the radial direction relative to the longitudinal axis X. The terms upstream and downstream are defined relative to the general direction of flow of the gases in the turbine engine along the longitudinal axis X around which the turbine engine extends.

Reference is now made to FIG. 2A schematically showing a partial view of a low-pressure turbine 7 with a longitudinal axis which comprises alternating annular rows of moving blades 9 arranged longitudinally alternating with annular rows of stator vanes 10. Only two annular rows of rotor blades 9 and an annular row of stator vanes 10 are shown in FIG. 2A. The annular rows of rotor blades 9 or moving blades 9 are connected to each other by a cylindrical shroud 11.

Each of the annular rows of stator vanes 10 comprises a radially inner annular platform 12 and a radially outer annular platform (not shown) between which a plurality of blades 13 extend. The radially outer annular platform is attached to a casing of the turbine.

Managing the sealing between the end of the stator vanes 10 and the shroud 11 of the rotor is important to limit the gas leaks between the rotor and the stator 10 and to control the pressure and temperature conditions on either side of said seal and also radially below the seal. For this purpose, it is known to provide a radial annular partition wall 14 extending from said radially internal annular platform inwards, and carrying at one end a sealing member 15 intended to maintain in operation a small clearance with the corresponding shroud of the rotor.

For this purpose and as shown in FIGS. 2A and 2B, the annular row of stator vanes 10 carries a clearance-controlled annular seal 15 arranged radially inside the annular row of stator vanes 10 and radially outside the cylindrical shroud 11, the clearance-controlled annular seal 22 cooperating in a non-contact sealing manner with the cylindrical shroud 11 in order to limit the flow from upstream of the annular row of stator vanes 10 to downstream in the annular space between the seal 15 and the cylindrical shroud 11.

In particular, such a clearance-controlled seal 15 operates with a low and controlled annular clearance between the latter and the shroud 11 when the turbine is in operation. Moreover, this type of seal aims to adapt the clearance during operation. The use of the hydrostatic seal 15 therefore has the advantage of limiting leakage flow at the seal, thereby improving the performance of the turbine engine and reducing the requirements in terms of thermal and mechanical stresses when sizing the various components of the turbine 7.

As shown in FIG. 2B, the hydrostatic annular seal 15 can be formed by two concentric annular walls 16, 17, and of a plurality of elastically deformable members arranged circumferentially next to each other and extending between the two walls 16, 17 and including in particular elastically deformable blades 18 extending circumferentially. For example, WO 2009/148787 describes such a seal. This configuration improves control of the radial deformation of the seal 15, and therefore control of the clearance between the seal 15 and the shroud 11 cooperating with the seal 15 so as to limit the passage of air.

It has been observed that the segmentation of the hydrostatic annular seal could lead to parasitic air flows between the seal segments, which leads to reduced seal efficiency.

The present document provides a simple, reliable and economical solution to this need.

### SUMMARY

A seal is thus proposed for an aircraft turbine engine comprising a plurality of seal segments that are circumferentially distributed about a longitudinal axis, each seal segment comprising a radially outer annular wall segment and a radially inner annular wall segment which are connected to each other by an elastically deformable member characterized in that the radially outer annular wall segments form a monolithic outer shroud and the radially inner annular wall segments are arranged circumferentially end-to-end and in that each radially inner annular wall segment comprises a first circumferential edge and an opposite second circumferential edge which each have a slit and in that a tongue is mounted in part in a slit of a first circumferential edge of a radially inner annular wall segment and in a slit circumferentially opposite a second circumferential edge of a circumferentially adjacent radially inner annular wall segment.

The insertion of a tongue between two circumferentially consecutive shoes makes it possible to reduce the passage of parasitic air in the space between two facing circumferential edges of the two circumferentially adjacent shoes.

Each slit may have a radial dimension between 0.5 and 1.2 mm, preferably about 0.8 mm.

Each tongue may have a longitudinal dimension less than a circumferential dimension, a radial dimension being less than the longitudinal dimension.

The tongues may be arranged between the upstream end and a longitudinal median plane of the radially inner annular wall segment.

The tongues may have a substantially rectangular shape.

This document also relates to an assembly comprising a cylindrical rotor shroud intended to be rotated about the longitudinal axis and a distributor which has a stator vane ring, the distributor including a foot at the radially inner end of the distributor, a seal being mounted on the foot of the distributor, and the seal cooperating in a non-contact sealing manner with the cylindrical rotor shroud of the turbine engine arranged radially under the distributor.

The invention also relates to a turbine for an aircraft turbine engine, the turbine comprising a casing, an assembly and a rotor which comprises a cylindrical shroud rotated about the longitudinal axis and the distributor being mounted in the casing and the cylindrical shroud being arranged radially under the distributor.

Finally, the document relates to a turbine engine, such as an aircraft turbojet or turboprop engine, comprising an assembly or a turbine.

### BRIEF DESCRIPTION OF THE DRAWINGS

Further characteristics, details and advantages will become apparent upon reading the detailed description below, and upon examining the appended drawings, in which:

FIG. 1 schematically shows a sectional view of an exemplary turbine engine;

FIG. 2A and FIG. 2B schematically show a partial view of part of a turbine, for example a low-pressure turbine, FIG. 2B being an enlargement of the seal shown in FIG. 2A;

FIG. 3 schematically shows an annular seal;

FIG. 4 schematically shows part of an annular row of stator vanes and a seal according to this document;

FIG. 5 is a larger-scale view of the seal shown in FIG. 4;

FIG. 6 and FIG. 7 schematically show the sealing principle of the seal according to this document;

FIG. 8 schematically shows a first seal according to this document;

FIG. 9 schematically shows a second seal according to this document;

FIG. 10 to FIG. 16 schematically show a third type of seal according to this document as well as variants thereof;

FIG. 17 to FIG. 20 schematically show alternative embodiments of the connecting legs between a radially outer annular wall and the radially inner annular walls for a seal;

FIG. 21 is a three-dimensional schematic view of a segment of an annular row of stator or distributor vanes according to this document;

FIG. 22 is a schematic perspective view of part of a hydrostatic annular seal;

FIG. 23 is a schematic perspective view of the legs of a hydrostatic annular seal;

FIG. 24 and FIG. 25 are schematic perspective views of the radial sliding means between the hydrostatic annular seal and the annular row of stator vanes;

FIG. 26 is a sectional view of an assembly according to this document;

FIG. 27 to FIG. 33 are schematic perspective views of an assembly comprising a hydrostatic annular seal according to this document;

FIG. 34A, FIG. 34B, FIG. 35A and FIG. 35B are schematic perspective views of an assembly according to this document and comprising a hydrostatic annular seal form-fittingly connected to radial sliding connection means on an annular row of stator vanes;

FIG. 36 is a schematic perspective view of a circumferential edge of an annular seal as described in this document;

FIG. 37A, FIG. 37B, FIG. 37C and FIG. 37D are schematic illustrations of an annular seal according to this document, the annular seal having a housing on its radially inner face;

FIG. 38 schematically shows a partial view of an exemplary assembly according to this document, this assembly comprising an annular seal;

FIG. 39 schematically shows an enlarged partial view of an exemplary assembly according to FIG. 38;

FIG. 40 schematically shows an enlarged partial view of another exemplary assembly according to FIG. 38;

FIG. 41 schematically shows respectively a partial view of an exemplary assembly according to this document, and two enlarged partial views of the exemplary assembly in two different configurations;

FIG. 42 schematically shows a partial view of an exemplary hydrostatic annular seal;

FIG. 43 schematically shows a partial cross-sectional view of an exemplary assembly according to this document;

FIG. 44 schematically shows a partial cross-sectional view of another exemplary assembly according to this document;

FIG. 45 schematically shows a partial cross-sectional view of another exemplary assembly according to this document;

FIG. 46 schematically shows a partial cross-sectional view of another exemplary assembly according to this document.

### DESCRIPTION OF THE EMBODIMENTS

This document relates to an annular seal such as a hydrostatic annular seal used in a turbine engine. In particular, it comprises different embodiments and ways of integrating such a hydrostatic annular seal.

Reference is made to FIG. 3 schematically showing a partial view of a hydrostatic annular seal 51 according to this document. Preferably, this hydrostatic annular seal 51 is integrated into an assembly 52 for a turbine engine with a longitudinal axis X. Such an assembly is used in a turbine, in particular a low-pressure turbine, of a turbine engine. This document also relates to any type of turbine engine comprising such a turbine, for example a turboprop or turbojet for an aircraft.

The assembly 52 comprises a cylindrical shroud 53 intended to be rotated about the longitudinal axis X and an annular row of stator vanes. The assembly may also include two annular rows of moving blades arranged longitudinally on either side of the annular row of stator vanes 54 and connected to each other by the cylindrical shroud 53. The annular row of stator vanes 54 carries the hydrostatic annular seal 51. This hydrostatic annular seal 51 is arranged radially inside the annular row of stator vanes 54 and radially outside the cylindrical shroud 53, the hydrostatic annular seal 51 cooperating in a non-contact sealing manner with the cylindrical shroud 53.

The hydrostatic annular seal 51 preferably comprises a radially outer annular wall 55, a radially inner annular wall 56 and a plurality of elastically deformable members or elements 57, in particular circumferentially distributed about the longitudinal axis X. The hydrostatic annular seal 51 can deform radially thanks to the flexibility offered by the elastically deformable member 57 connecting together the radially inner annular wall 56 and the radially outer annular wall 55. The radially inner 56 and outer 55 annular walls and the elastically deformable element 57 are in particular dimensioned to control the radial deformation of the hydrostatic annular seal 51, and therefore control a clearance J2 between the hydrostatic annular seal 51 and the cylindrical shroud 53.

The seal may comprise a plurality of seal segments distributed circumferentially about the longitudinal axis, each seal segment including a radially inner annular wall segment 56 and a radially outer annular wall segment 55 which are connected to each other by an elastically deformable member 57. The radially outer annular wall segments can form a monolithic outer shroud, i.e. in one-piece, and the radially inner annular wall segments are separate and arranged circumferentially end-to-end.

A turbine is a system that expands air from high pressure upstream to low pressure downstream. There must be as much air as possible passing through the turbine and not escaping from the flow path. An air layer coming from the annular cavity located upstream of the seal 51 passes between the cylindrical shroud 53 and the seal 51 whose differences in radial dimensions form the clearance J2. By maintaining a small radial clearance, the hydrostatic annular seal 51 provides sealing. It is the pressure differential between the annular cavity upstream of the hydrostatic annular seal 51 and the annular cavity immediately downstream of this hydrostatic annular seal 51 that controls the resultant radial pressure forces acting on the radially inner annular wall 56 of the hydrostatic seal 51.

The hydrostatic annular seal 51 includes an inner surface 59 arranged radially facing the cylindrical shroud 53. This inner surface 59 includes a first substantially cylindrical surface part 60, a second concave curved surface part 61 with a concavity curved radially outwards so as to form an annular cavity facing the cylindrical shroud 53, a third substantially cylindrical surface part 62 and a fourth frustoconical surface part 63 with a cross-section increasing towards the downstream side. There is a clearance j1 between the first surface part 60 and the cylindrical shroud 53, and a clearance j2 between the third surface part 62 and the cylindrical shroud 53. The clearances j1 and j2 are such that the clearance j1 is greater than j2. This difference in clearances between j1 and j2 generates a restriction. This restriction accelerates the air and causes a loss of static pressure in the event of a high clearance j1 (>0.6 mm for example). The hydrostatic annular seal 51 deforms under the resultant mechanical forces exerted on the inner surface 59 and the outer surface 63 of the shoe segment 58. This specific configuration makes it possible to maintain a small clearance and therefore high-performance sealing, without the risk of contact between the shoe segment 58 and the shroud 53.

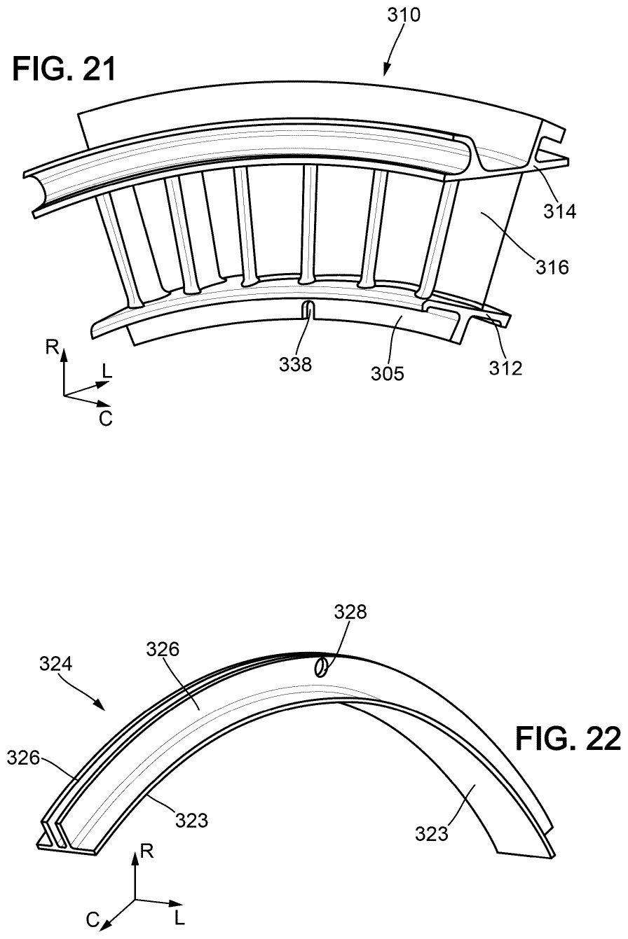

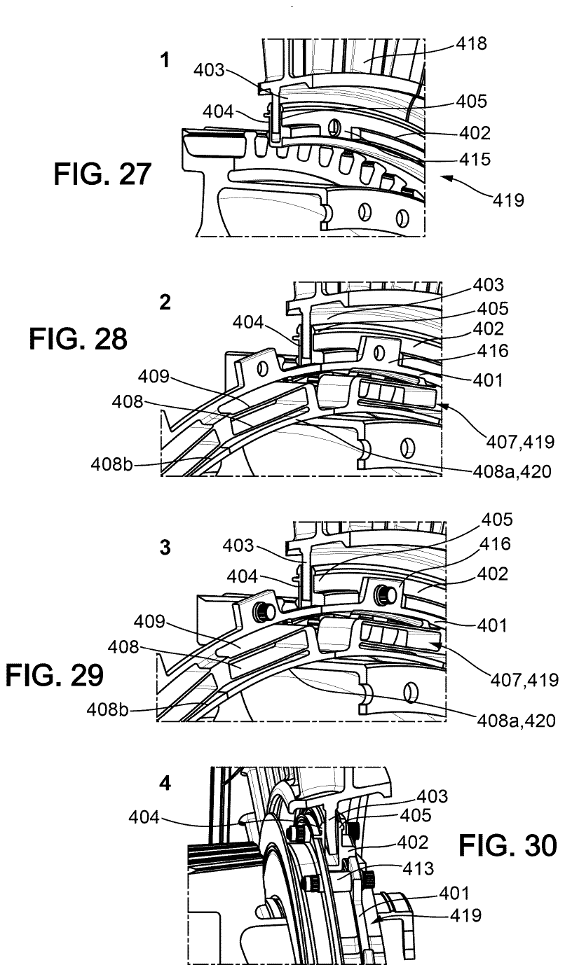

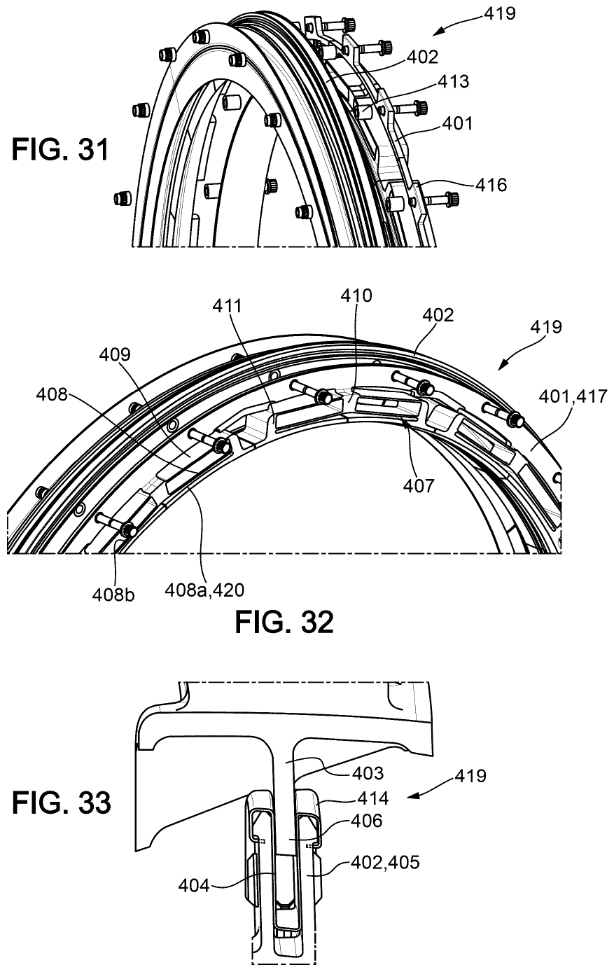

The annular row of stator vanes 54 comprises a radial annular partition wall 64 bearing the hydrostatic annular seal 51. The hydrostatic annular seal 51 may comprise means for radial sliding 65 in the direction of the annular row of stator vanes 54. The radially outer annular wall 55 is connected to an annular part 71 including an upstream annular leg 66 and a downstream annular leg 67 each comprising longitudinally opposing holes 68, in which pins 69 are mounted. The outer annular wall 55 and the annular part 71 can be made in one piece. The pins 69 are interference-fitted into the holes 68 of one of the upstream 66 and downstream 67 annular legs only so as to allow insertion into the other of the upstream 66 and downstream 67 annular legs. Preferably, the interference-fitting is carried out on the upstream annular leg 66. The radial annular partition wall 64 of the annular row of stator vanes 54 comprises a plurality of preferably oblong openings 70 in which an intermediate part of the pins 69 are mounted. Alternatively, the openings may be rectangular. This mounting allows a degree of freedom in the radial direction of the hydrostatic annular seal 51 with respect to the annular row of stator vanes 54. Other means of radial displacement could be envisaged. The radial sliding of the hydrostatic annular seal 51 can be carried out as in FIGS. 21 to 26, but also as in FIGS. 27 to 33.

Thus, a degree of freedom in the radial direction is left to the hydrostatic annular seal 51 when the turbine engine is in operation. Indeed, under the effect of heat, expansions of the annular row of stator vanes 54 facing the annular part 71 occur. The U-shape produced by the connection between the upstream annular leg 66 and the downstream annular leg 67 facilitates the assembly and radial sliding guidance of the seal on the annular partition wall 64. This U-shape therefore expands radially under the effect of expansion and this U-shape ensures that there is no radially outward thrust. Thus, the hydrostatic annular seal 51 is guided and undergoes little deformation due to temperature differences with the adjacent/neighboring components both in the radial direction, as well as in the circumferential or even longitudinal direction.

In order for the pressure differential described above to exist between the upstream cavity and the downstream cavity of the turbine, it is necessary to produce a secondary seal 72. This secondary seal 72 prevents leakage between the radially inner annular wall 56 and the radially outer annular wall 55, ensuring that air flows only between the cylindrical shroud 53 and the radially inner annular wall segments 56.

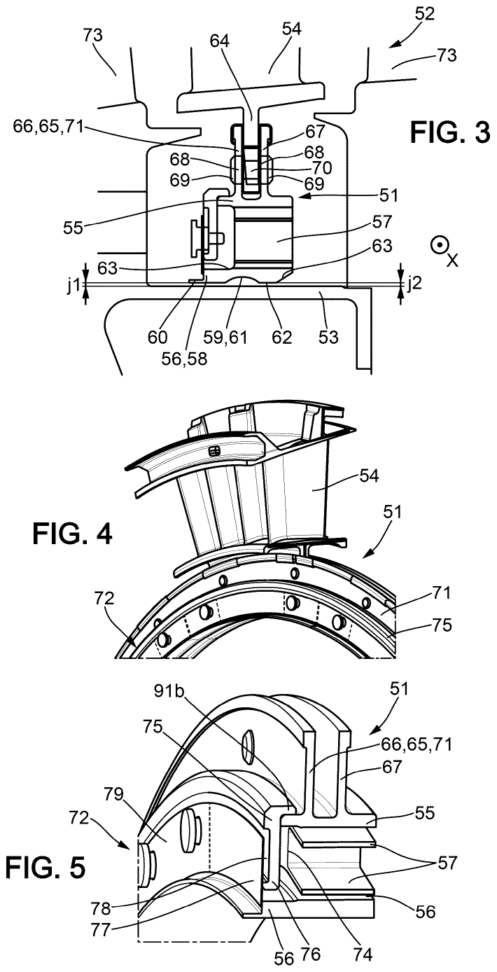

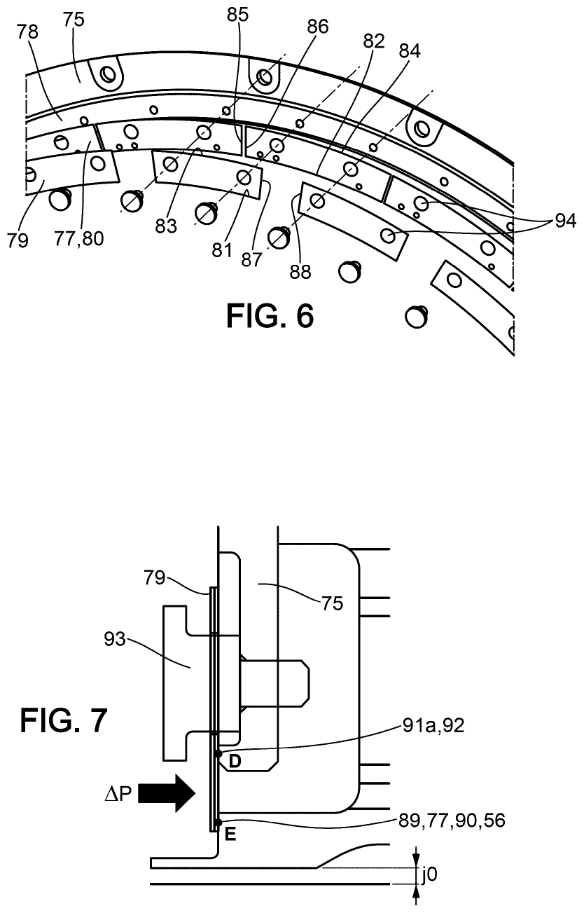

For this purpose, reference is now made to FIGS. 4 to 7.

FIGS. 4 and 5 show the hydrostatic annular seal 51 fitted with the secondary seal 72 and attached to the annular row of stator vanes 54. This hydrostatic annular seal 51 is intended to be arranged longitudinally between two annular rows of rotor vanes 73 arranged on either side of an annular row of stator vanes 54. As described above, the hydrostatic annular seal 51 comprises a radially inner annular wall 56, a radially outer annular wall 55 which are connected to each other by the elastically deformable members 57. An annular flange is arranged facing the upstream faces 74 of the elastically deformable members 57. This flange is supported by the radially outer annular wall 55. There is an annular clearance between a radially inner end 76 of the ring 75 and the radially inner annular wall 56. This annular clearance is sealed by the secondary seal 72 which will be described in more detail.

As shown in FIGS. 4 to 6, a first annular row of first plate segments 77 is arranged circumferentially end-to-end and applied to an upstream face 78 of the ring 75. A second annular row of second plate segments 79 is applied to upstream faces 80 of the first annular row of the first plate segments 77. The plate segments 77,79 are between 0.1 and 0.6 mm thick. The second plate segments 79 can be arranged circumferentially by being offset with respect to the first plate segments 77 so that a second plate segment 79 is arranged longitudinally facing two first circumferentially adjacent plate segments. The inner edges 81 of the second plate segments 79 are longitudinally aligned with the inner edges 82 of the first plate segments 77. The outer edges 83 of the second plate segments 79 are longitudinally aligned with the outer edges 84 of the first plate segments 77. The circumferential edges 85, 86 of the first plate segments 77 are misaligned with the circumferential edges 87, 88 of the second plate segments 79. The misalignment of the circumferential edges 85, 86, 87, 88 of the first 77 and second plate segments 79 prevents leaking due to the annular clearance.

More precisely, as shown in FIG. 7, the radially inner ends 89 of the first plate segments 77 rest on a radial face 90 of the radially inner annular wall 56. The flange 75 comprises an inner annular rim 91a which extends upstream. An upstream face 92 of the ring 75 is formed at the upstream end of the inner annular rim 91a of the flange 75. The first annular row of first plate segments 77 is arranged circumferentially end-to-end and applied to the upstream face 92 of the ring 75. The material of the first plate segments and that of the flange is determined in such a way as to facilitate sliding between these two parts.

The flange 75 also comprises an annular rim 91b extending downstream and formed at its radially outer end. As shown in FIG. 5, the annular rim 91b radially covers the upstream ends of the radially outer annular wall segments.

As shown in FIGS. 4 to 7, the plate segments 77, 79 are attached to the ring 75 by fastening elements 93 passing through openings 94 on the plate segments 77, 79. These fastening elements 93 fix the first 77 and second plate segments 79 together to the ring 75, which is itself supported by the radially outer annular wall 66. The fastening elements may be pins. The openings 94 are such that there is a clearance and the plate segments 77, 79 are capable of moving slightly.

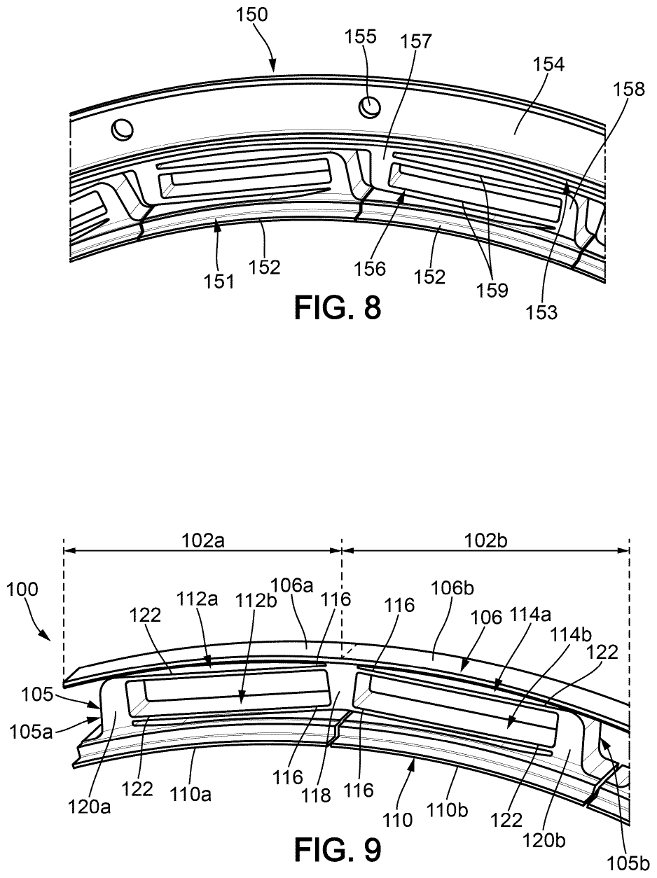

Reference is now made to FIG. 8 which shows a hydrostatic annular seal 150 intended to provide a seal between a stator annular row to which it is connected and a cylindrical shroud as described with reference to FIGS. 2A and 2B. As shown in FIG. 8, the annular seal 150 which is of a known type comprises an inner annular wall 151 formed by segments 152 arranged circumferentially end-to-end. It also comprises an outer annular wall 153 from which at least one annular leg or wall 154 may extend including at least one hole 155 for inserting a shaft preferably embodied by a pin, or alternatively by the smooth shank of a screw, or a spacer, intended to cooperate with an oblong opening of a radial annular partition wall supported by the inner annular platform of the annular row of stator vanes.

Each radially inner annular wall segment 152 is connected to the outer annular wall 153 by an elastically deformable member 156. Thus, each radially inner annular wall segment is associated with an elastically deformable member 156.

Each elastically deformable member 156 comprises two elastic strips 159 extending circumferentially and parallel to one another. First ends of the strips 159 are connected to a first radial leg 158 supported by a radially inner annular wall segment and second ends of the strips 159 are connected to a second radial leg 157 supported by the radially outer annular wall 153. Although this type of embodiment proves effective, it does not provide the best compromise between radial flexibility and torsional resistance for a given thickness of strips as mentioned with reference to the prior art at the beginning of the description.

Thus, a hydrostatic annular seal 100 formed by a plurality of circumferentially distributed seal segments is proposed, only one being shown in FIG. 9. Each seal segment 102a, 102b comprises a radially outer annular wall segment 106a, 106b and a radially inner annular wall segment 110a, 110b connected to each other by an elastically deformable member 105a, 105b, wherein the seal segments 102a, 102b, paired circumferentially adjacent, have their respective elastically deformable member 105a, 105b formed monolithically as a common elastically deformable member 105, the common deformable elastic member 105 connecting together two radially inner annular wall segments 110a, 110b of circumferentially adjacent seal segments and wherein the radially outer annular wall segments 106a, 106b of the seal segments form a monolithic outer shroud 106.

Thus, each common elastic member 105 is elastically connected to at least two radially inner annular wall segments 110a, 110b, in this case exactly two, which are circumferentially adjacent and to two radially outer annular wall segments 106a, 106b 106. The radially inner annular wall segments 110a, 110b successively form the radially inner annular wall of the hydrostatic annular seal 100. In the embodiment shown in FIG. 9, each elastically deformable member 105 is connected to two circumferentially adjacent inner segments 110a, 110b, one 110a being referred to as a primary segment and the other 110b being referred to as secondary segment.

It is observed that each common elastic member 105 comprises at least one first elastically deformable circumferential strip 112a, 112b and at least one second elastically deformable circumferential strip 114a, 114b connected by first circumferential ends, which face each other, to the outer annular wall and whose second ends 122 circumferentially opposite each other with respect to the first ends are each connected to the primary segment 110a and to the secondary segment 110b. Said first end 116 of said at least one first strip 112a, 112b and said first end 116 of said at least one second strip 114a, 114b are arranged in circumferential opposition.

In FIG. 9, it is observed that said at least one first strip 112a, 112b and said at least one second strip 114a, 114b comprises two strips which are radially spaced apart from one another. The first strips 112a, 112b and/or the second strips 114a, 114b may be substantially parallel to each other as shown in FIG. 9. The first strips 112a, 112b and/or the second strips 114a, 114b may also form an angle between them. Out of the first strips 112a, 112b, a first strip 112b is a first inner strip 112b and the other 112a is a first outer strip. Out of the second strips 112a, 112b, a second strip 112b is a second inner strip and the other 112a is a second outer strip.

The first ends 116 of the first and second elastic strips may be connected, as shown in FIG. 9, to the same first leg 118 which can extend substantially radially. The first inner strip 111b and/or the second inner strip 114b may be connected to the radially inner end of the first leg 118. The first outer strip 112a and/or the second outer strip 114a may be connected to the vicinity of the radially outer end of the first leg 118, this radially outer end of the first leg 118 being connected to the radially outer annular wall.

The radially inner end of the first leg 118 is devoid of a direct connection to one of the two circumferentially adjacent primary 110a and secondary 110b segments, the connection of the first leg 118 with the segments 110a, 110b being made indirectly by the first 112a, 112b and second strips 114a, 114b and the second legs 120a, 120b, the latter being described in the following paragraphs.

In the embodiment shown in FIG. 9, the legs are dimensioned so as not to be deformable, the deformation occurring at the strips.

The second ends 122 of the first and second elastic strips may be connected, as shown in FIG. 9, to the a second leg 120a, 120b which can extend substantially radially. It is observed that there are two second legs 120a, 120b which are arranged circumferentially on either side of the first leg 118 and which can be positioned circumferentially substantially symmetrically to one another with respect to the position of the first leg 118. A second leg referred to as second primary leg 120a is connected to the second ends of the first strips 112a, 112b and a second leg referred to as second secondary leg 120b is connected to the second ends of the second strips 114a, 114b.

According to the embodiment shown in FIG. 9, the common elastically deformable member thus has a first circumferential end radial leg 120a connected to a circumferential end of the inner annular wall segment 110a of a first seal segment 102a and a second circumferential end radial leg 120b connected to a circumferential end of the inner annular wall segment 110b of a second seal segment 102b, each circumferential end radial leg 120a, 120b being connected to a common radial leg 118 by a first strip 112a, 112b and a second strip 114a, 114b which each extends circumferentially to connect each circumferential end radial leg 120a, 120b to a common radial leg 118.

The term “primary” and the term “secondary” only make it possible to distinguish between the two second legs 120a, 120b and their connection to the primary segment 110a and secondary segment 110b.

The first outer strip 112a and/or the second outer strip 114a may be connected to the radially outer end of the second primary 120a and secondary 120b legs. The first inner strip 112b and/or the second inner strip 114b may be connected to the vicinity of the radially inner end of a second leg 120a, 120b, this radially inner end of a second leg 120a, 120b being connected to a shoe 110a, 110b. More precisely, the radially inner end of the second primary leg 120a is connected to the primary segment 110a and, for example, to the vicinity of a circumferential end thereof. The radially inner end of the second secondary leg 120b is connected to the secondary shoe 110b and, for example, to the vicinity of a circumferential end thereof. Said two ends of the primary segment 110a and the secondary segment 110b are opposite to their ends that face each other circumferentially.

With reference to FIG. 8, the aforementioned embodiment makes it possible to remove a connecting leg for each pair of primary 110a and secondary segments 110b, which makes it possible to lighten the structure of the hydrostatic annular seal 100. A significant gain in space is also obtained in the circumferential direction. With constant stiffness compared to the prior art, it is thus possible to use thicker strips, thereby limiting torsion. Thus, for each pair of primary 110a and secondary segments 110b, it is necessary to have only three legs instead of four as in FIG. 8.

The annular seal 100 could comprise means that enable radial sliding of the hydrostatic annular seal with respect to the radial annular partition wall of the annular row of stator vanes. These means may, for example, be of the type of those described with reference to FIGS. 21 to 25 or with reference to FIGS. 27 to 33.

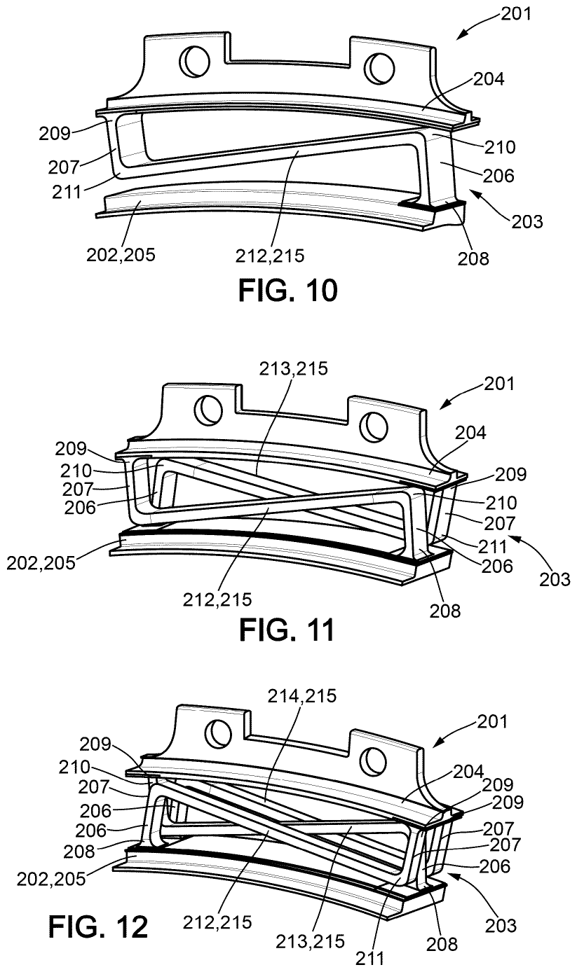

Reference is now made to FIGS. 10 to 20.

FIGS. 10 to 16 schematically show a third hydrostatic annular seal 201 as well as variants thereof.

FIG. 10 shows a hydrostatic annular seal 201 including a radially inner annular wall 202, an elastically deformable member 203 and a radially outer annular wall 204. The radially inner annular wall 202 is formed by a plurality of shoe segments 205. The shoe segment 205 shown is connected to the radially outer annular wall 204 by the elastically deformable member 203. This elastically deformable member 203 includes an inner leg 206 and an outer leg 207. Each leg 206, 207 is substantially flat. The inner leg 206 includes a radially inner end 208 to which said shoe segment 205 is attached. The outer leg 207 includes a radially outer end 209 to which the radially outer annular wall 204 is attached. The inner leg 206 includes a radially outer end 210 connected to a radially inner end 211 of the outer leg 207 by a connecting wall 215. In the embodiment shown in FIG. 10, the inner leg 206 and the outer leg 207 extend radially such that the radially inner end 211 of the outer leg 207 is arranged radially inside the radially outer end 210 of the inner leg 206.

The hydrostatic annular seal 201 shown in FIG. 11 includes an elastically deformable member 203 formed by a plurality of elastically deformable members. It thus comprises a first elastically deformable member 212 and a second elastically deformable member 213. The first 212 and second 213 elastically deformable members are arranged so that the inner leg 206, respectively the outer leg 207, of the first member 212 is axially adjacent to the outer leg 207, respectively the inner leg 206, of the second member 212.

The hydrostatic annular seal 201 shown in FIG. 12 includes an elastically deformable member 203 formed by three elastically deformable members, a first member 212, a second member 213 and a third member 214. The first 212 and second 213 members are arranged so that the inner leg 206, respectively the outer leg 207, of the first member 212 is axially adjacent to the outer leg 207, respectively the inner leg 206, of the second member 213. The third member 214 is arranged so that its outer leg 207, respectively its inner leg 206, is axially adjacent to the inner leg 206, respectively the outer leg 207, of the second member 212.

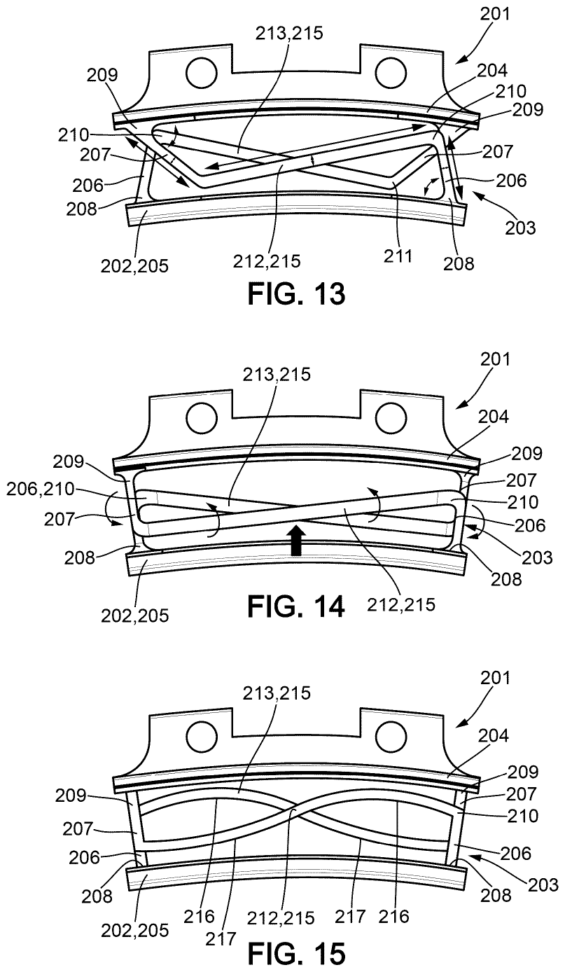

The outer leg 207 may be inclined relative to a tangent to the radially outer annular wall 204 at the connection point between the outer leg 207 and the radially outer annular wall 204. Similarly, the inner leg 206 may be inclined relative to a tangent to the radially inner annular wall 202 at the connection point between the inner leg 206 and the radially inner annular wall 202. This angle may be between 10° and 150°. It is thus understood that the inner leg 206 and the outer leg 207 can have different inclinations as clearly seen in FIG. 13. Other embodiments are of course possible. The inclination of the legs 207, 206 relative to the radial direction makes it possible to restrict the displacement of the elastically deformable member in the longitudinal direction.

Each connecting wall 215 may comprise a thickness, defined by the radial dimension of the connecting wall 215, between 0.5 and 10 mm and/or a width, defined by the longitudinal dimension of the connecting wall 215, between 2 and 30 mm.

Each leg 206, 207 may comprise at least one of the following parameters:
A width in the longitudinal direction between 2 and 30 mm,
A dimension in its direction of extension between its radially inner and outer ends between 3 and 60 mm,
A dimension perpendicular to the direction of extension of the leg between 0.5 and 10 mm.

As shown in FIG. 14, the hydrostatic annular seal 201 includes first 212 and second 213 members. The connecting wall 215 makes it possible to restrict the upstream/downstream tilting movements due to its resistance to torsion. The inner and outer legs 206, 207 which are also deformable allow predominantly radial movement by bending of the elastically deformable member. The inclination of the legs 206 and 207 with respect to the inner 202 and outer 204 annular wall makes it possible to limit the displacement of the shoe 205 in the longitudinal axis As shown in FIG. 15, the hydrostatic annular seal 201 may include a first 212 and a second 213 elastically deformable member. The connecting wall 215 of the first member 212 comprises a radially inner surface formed successively by a concave surface 216 then a convex surface 217. The connecting wall 215 of the second member 213 comprises a radially inner surface formed successively by a convex surface 217 then a concave surface 216.

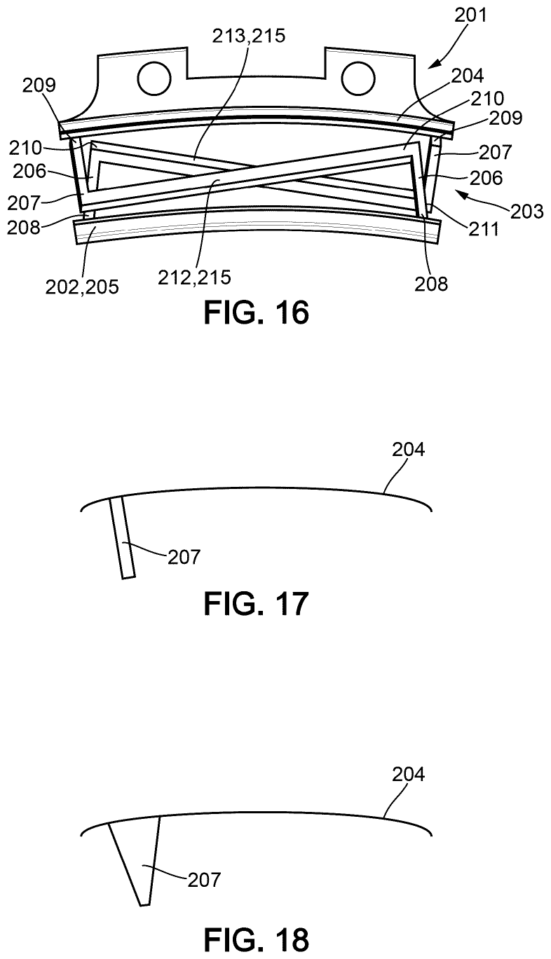

The hydrostatic annular seal 201 shown in FIG. 16 includes an elastically deformable member 203 comprising a first 212 and a second 213 member. The connection between the radially outer end 210 of the inner leg 206 and the connecting wall 215 of each member is at right angles. Similarly, the connection between the radially inner end 211 of the outer leg 207 and the connecting wall 215 of each member is also at right angles. FIG. 16 shows the oblique inclination of the members 212, 213.

FIGS. 17 to 20 schematically show alternative embodiments of the connecting legs of the connecting walls 215 to the radially inner 202 and outer 204 annular walls for a hydrostatic annular seal 201. Only an outer leg 207 is shown but the description also applies to an inner leg 206.

FIG. 17 shows a leg 207 with a substantially constant cross-section between its inner and outer ends.

FIG. 18 shows a leg 207 with a cross-section that changes radially and that increases in the particular case of FIG. 18. The general shape here is triangular.

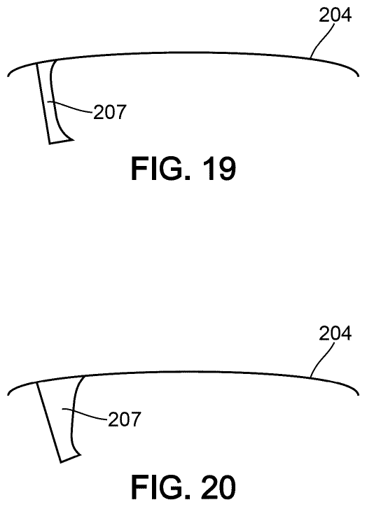

FIG. 19 shows a leg 207 including a circumferential surface oriented towards the other leg which is concave and an opposite circumferential surface which is substantially flat.

FIG. 20 also shows a leg 207 including concave and flat circumferential surfaces as in FIG. 19. However, in this embodiment, the radially inner end of the leg has a smaller dimension than the radially outer end.

The hydrostatic annular seal 201 comprises at least one material or a combination of materials from the following list: steel, titanium, aluminum alloy, cobalt-based alloy, nickel-based alloy, and/or any composite material.

Reference is now made to FIGS. 21 to 26 which relate to the radial sliding of a hydrostatic annular seal 300 on an annular partition wall 305 of an annular row of stator vanes.

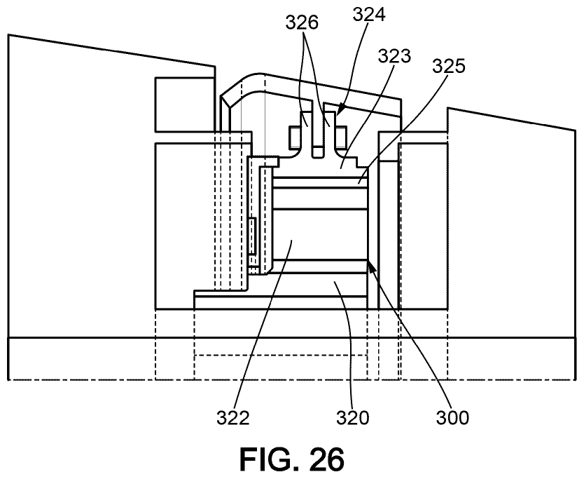

FIG. 21 shows a segment 310 of an annular row or ring of stator vanes which is a distributor in this case. Such segments are arranged circumferentially end-to-end to form the stator vane ring. This ring carries a hydrostatic annular seal 300 which is shown in FIG. 26. It could be of any type as described in this description, for example those described with reference to FIG. 9 or FIGS. 10 to 20.

All ring segments 310 of the distributor are identical so that the following description, which relates to a segment shown in FIG. 21, applies to each of the other segments 310 of the distributor.

With reference to FIG. 21, the segment comprises an inner platform 312, an outer platform 314, and blades 316.

The blades 316 are each connected, on the one hand, to the inner platform 312 and, on the other hand, to the outer platform 314 so as to extend radially through a primary air path, which is radially delimited by these platforms 312, 314.

The blades of the segment 310 are circumferentially spaced apart from each other. The outer platform 314 is configured to be attached to a casing of the turbine engine 1.

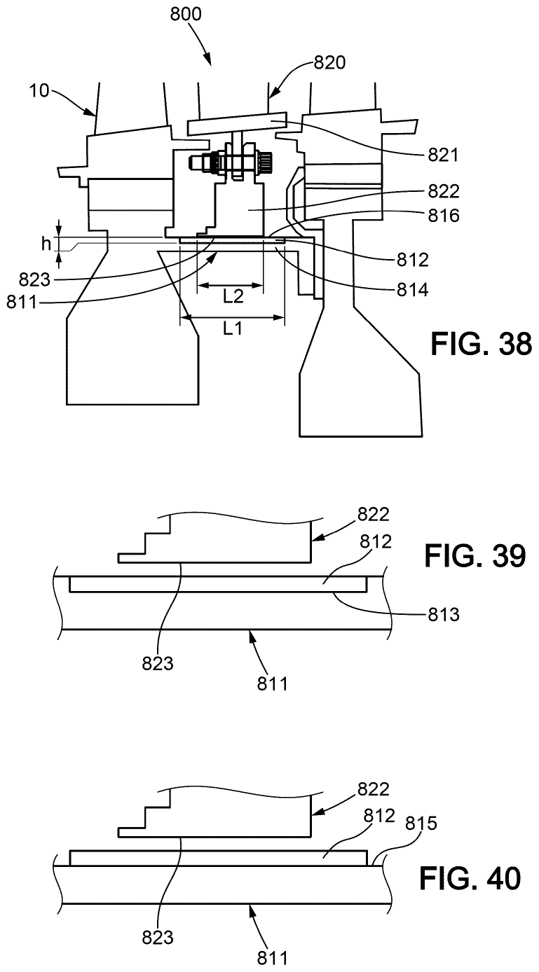

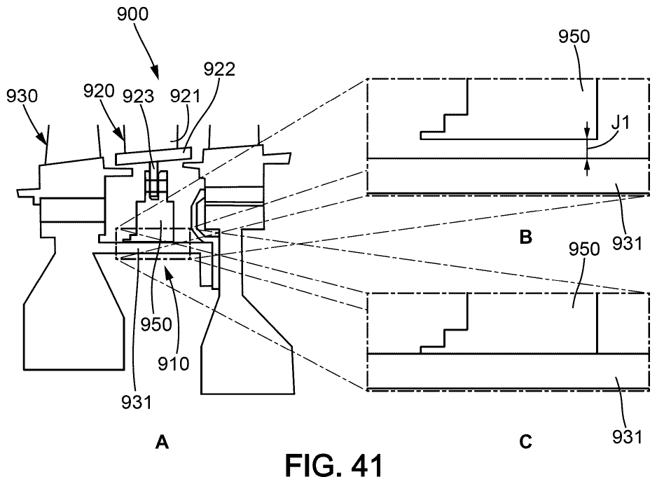

The segment 310 comprises a radial partition wall 305 forming the foot of the distributor 310 and which is connected to the inner platform 312 so as to extend radially inwards from the inner platform 312, in the direction of a cylindrical shroud 11 of the rotor, the cylindrical shroud being shown in FIGS. 2A and 2B, or FIG. 38 or FIG. 41.

The radial partition wall 305 is configured to cooperate with a hydrostatic annular seal 300 (FIG. 26). The hydrostatic annular seal 300 comprises a segmented radial annular wall 320, formed by a plurality of radially inner annular wall segments arranged circumferentially end-to-end. The latter are connected by elastically deformable members 322 to a radially outer annular wall 325 attached to the seal support 324 which comprises a radially outer annular wall 323 and radially outwardly at least one radial annular leg 326, preferably two radial annular legs as shown in FIG. 22.

In this respect, FIG. 22 shows only a circumferential section of the seal support 324.

With reference to FIG. 22, the radial annular legs 326 or flanges are substantially parallel and longitudinally spaced apart from each other so as to form a U-section defining a space into which the radial partition wall 305305 of each of the segments 310 can be inserted.

The longitudinal distance between the legs 326 is selected to allow the longitudinal positioning and proper longitudinal retention of the segments 310, while still permitting radial sliding movement of the partition wall 305 between the legs 326 (see below). In particular, an axial or longitudinal clearance J1, J2 is left during assembly between the legs 326 and the partition wall 305 to allow this radial movement. The clearance J1 extends between the upstream leg 326 and the partition wall 305, and the clearance J2 extends between the partition wall 305 and the downstream leg 326.

Furthermore, the partition wall 305 is mounted with a radial clearance J3 with respect to the bottom of the space defined by the legs 326.

In the embodiment shown in FIG. 26, the radially outer annular wall 324 is formed integrally with the elastically deformable members 322, with the radially inner annular wall 320 and with at least one of the annular legs 326.

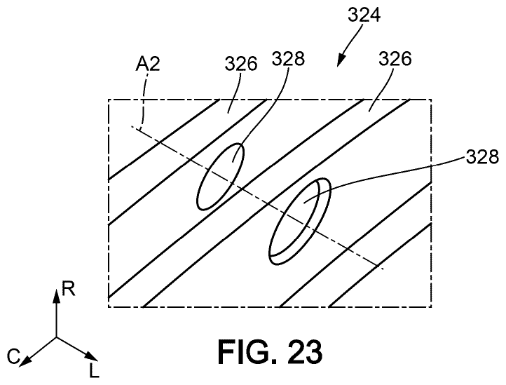

FIG. 23 shows two holes 328 made respectively in the upstream leg 326 and the downstream leg 326.

The holes 328 have a common axis A2 and are provided to receive a pin 330 such as that shown in Figure. The pin 330 is a cylindrical part with an axis A2 having two shoulders that define an upstream part 332, an intermediate part 334 and a downstream part 336.

The intermediate part 334 has a diameter smaller than the diameter of the upstream part 332 and the downstream part 336. The diameter of the upstream part is also smaller than that of the downstream part.

The hole 328 of the upstream leg 326 of the hydrostatic annular seal 300 is sized to receive the upstream part 332 of the pin 330 so as to form a tight fit. Similarly, the hole 328 of the downstream leg 326 of the hydrostatic annular seal 300 is sized to receive the downstream part 336 of the pin so as to form a tight or sliding fit.

After assembly, the pin 330 is thus supported by the upstream 332 and downstream 436 legs forming a complete connection with it.

The pin 330 is configured to cooperate with the distributor, in particular with the radial partition wall 305 of the segment 310.

With reference to FIG. 21, the partition wall 310 of each of the segments comprises for this purpose an opening 338 which has an oblong groove-type shape extending radially.

In this example, the opening 338 opens radially towards the inside of the ring segment 310. It may not open radially. This would require different geometric features of the pin and different assembly steps than those set out here.

The opening 338 has a width, or circumferential dimension, allowing it to be passed through by the intermediate part 334 of the pin 330, i.e. a width greater than the diameter of the intermediate part 334 of the pin 330.

The width of the opening 338 is furthermore smaller than the diameter of the upstream part 332 and the downstream part 336 of the pin 330. Thus, in the event of a break in the connection between the pin 330 and the upstream and downstream legs 326, the partition wall 305 of the segment 310 forms an axial stop for retaining the pin 330.

The assembly of this stator element comprises pre-insertion of the pin 330 into the upstream and downstream legs 326 by passing the upstream part 332 of the pin 330 through the hole 328 of the downstream leg 326.

The pin 330 is then fixed to the legs by forced insertion of its upstream part 332 into the hole 328 of the upstream leg 326 and, simultaneously, of its downstream part 336 into the hole 328 of the downstream leg 326.

The segment 310 is then moved radially inwardly so as to introduce the partition wall 305 axially between the legs 326 and to insert the intermediate part 334 of the pin 330 into the opening 338 of the partition wall 305.

These assembly steps result in the configuration shown in FIG. 25.

In this configuration, the pin 330 forms, on the one hand, a circumferential stop for the ring segment 310, preventing displacement of the hydrostatic annular seal 300 and the ring segment 310 relative to one another in rotation about the axis of the segment 310 and enabling the hydrostatic annular seal 300 to be centered relative to this axis A1.

On the other hand, given the respective dimensions of the intermediate part 334 of the pin 330 and 330 of the oblong opening 338, the assembly allows a radial displacement of the hydrostatic annular seal 300 relative to the segment 310.

The stator assembly may comprise other pins similar to the pin 330 each cooperating with the partition wall 305 according to the principles described above.

Of course, these principles can be generalized. For example, each of the segments 310 of the distributor may cooperate with a plurality of pins similar to the pin 330.

In general, the invention makes it possible to connect the hydrostatic annular seal 300 and the distributor 310 to one another according to a connection defining a degree of radial freedom or radial sliding capable of compensating for the differential thermal expansions within the turbine 9.

Finally, the forced fitting of the pins 330 in the holes 328 of the upstream and downstream legs 326 contributes to the reduction of gas leaks outside the core flow.

Reference is made to FIGS. 27 to 33.

The embodiment shown in FIGS. 27 to 32 of a hydrostatic annular seal 419 is proposed wherein a radially outer annular wall 401 is bolted to a seal support 402.

The hydrostatic annular seal 419 thus includes a segmented radially inner annular wall 420 and a radially outer annular wall 401 which is also segmented.

The seal support 402 is mounted for radial sliding on the radial annular partition wall 403 described above with reference to FIG. 21. The annular seal support 402 includes an upstream annular leg 404 and a downstream annular leg 405. The upstream annular leg 404 and the downstream annular leg 405 are connected to each other by a base so as to form a U. The radial annular partition wall 403 includes oblong openings 406 opening radially inwards.

In one particular embodiment, shown in FIGS. 27 to 31, the seal support 402 comprises longitudinal and circumferential protrusions 415 defining between them radial notches in which radial tongues 416 protruding radially outwardly from the radially outer annular wall segments 401 of the hydrostatic annular seal are engaged. This form-fit prevents the annular seal from rotating on the seal support 402.

As shown in FIG. 33, a plate 414 can be interposed longitudinally between the radial annular partition wall 403 and the seal support 402. The plate 414 comprises two radial annular arms connected to each other by a substantially cylindrical base. The arms comprise free end portions that are curved radially inwardly so as to form a curved portion that cooperates in a form-fitting manner with a lateral protrusion of the annular legs 404, 402 of the annular seal support.

Each elastically deformable member 407 can be elastically connected to at least two circumferentially adjacent radially inner annular wall segments 408a, 408b. In the embodiment shown in FIGS. 28, 29 and 32, each elastically deformable member 407 is connected to two circumferentially adjacent radially inner annular wall segments, one being referred to as a primary segment and the other being referred to as a secondary segment.

It is observed that each elastically deformable member 407 comprises at least one first elastically deformable circumferential strip 408 and at least one second elastically deformable circumferential strip 409 connected at a first common end to the radially outer annular wall 401 and whose second ends circumferentially opposite each other with respect to the first common end are each connected to a shoe radially inner annular wall segment 408a, 408b.

In FIGS. 28, 29 and 32, it is observed that said at least one first strip 408 and said at least one second strip 409 comprises two strips which are radially spaced apart from one another. The first strips and/or the second strips may be substantially parallel to each other as shown in FIGS. 28, 29 and 32. The first and/or second strips can also form an angle with each other. Out of the first strips, a first strip 408 is a first inner strip 408 and the other is a first outer strip 408. Out of the second strips, a second strip 409 is a second inner strip 409 and the other is a second outer strip 409.

Said first ends of the first and second elastic strips may be connected, as shown in FIGS. 28, 29 and 32, to the same first leg 410 which can extend substantially radially. The first inner strip 408 and/or the second inner strip 409 may be connected to the radially inner end of the first leg 410. The first outer strip 408 and/or the second outer strip 409 may be connected to the vicinity of the radially outer end of the first leg 410, this radially outer end of the first leg 410 being connected to the radially outer annular wall 401.

The radially inner end of the first leg 410 is devoid of a direct connection to one of the two circumferentially adjacent shoes, the connection of the first leg 410 with the radially inner annular wall being made indirectly by the first and second strips and the second legs, the latter being described in the following paragraphs.

Said second ends of the first and second elastic strips may be connected, as shown in FIGS. 28, 29 and 32, to a second leg 411 which can extend substantially radially. It is observed that there are two second legs 411 which are arranged circumferentially on either side of the first leg 410 and which can be positioned circumferentially substantially symmetrically to one another with respect to the position of the first leg 410. A second leg 411, referred to as second primary leg 411, is connected to the second ends of the first strips and a second leg 411 referred to as second secondary leg 411 is connected to the second ends of the second strips.

The expression “primary” and the expression “secondary” only make it possible to distinguish between the two second legs and their connection to the corresponding primary or secondary shoes.

The first outer strip 408 and/or the second outer strip 409 may be connected to the radially outer end of the second primary and secondary legs. The first inner strip 408 and/or the second inner strip 409 may be connected to the vicinity of the radially inner end of a second leg 411, this radially inner end of a second leg 411 being connected to a shoe. More precisely, the radially inner end of the second primary leg 411 is connected to the primary shoe and, for example, to the vicinity of a circumferential end thereof. The radially inner end of the second secondary leg 411 is connected to the secondary shoe and, for example, to the vicinity of a circumferential end thereof. Said two ends of the primary and secondary shoes are opposite to their ends that face each other circumferentially.

As shown in FIG. 30, a ring or spacer 413 acts as an axis to allow the seal support 402 to expand freely.

In one particular embodiment shown in FIG. 32, the radially outer annular wall 401 is formed by a radial ring 417.

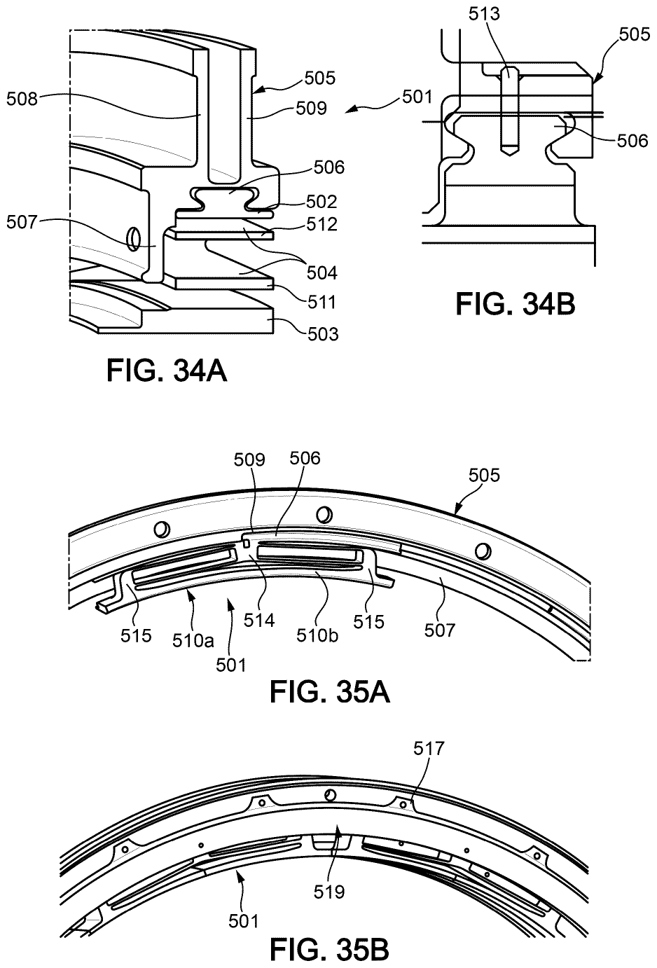

Reference is made to FIGS. 34A, 34B, 35A and 35B showing a hydrostatic annular seal 501. This hydrostatic annular seal 501 includes a segmented radially outer annular wall 502, a segmented radially inner annular wall 503 and an elastically deformable member 504 arranged between said two inner and outer walls.

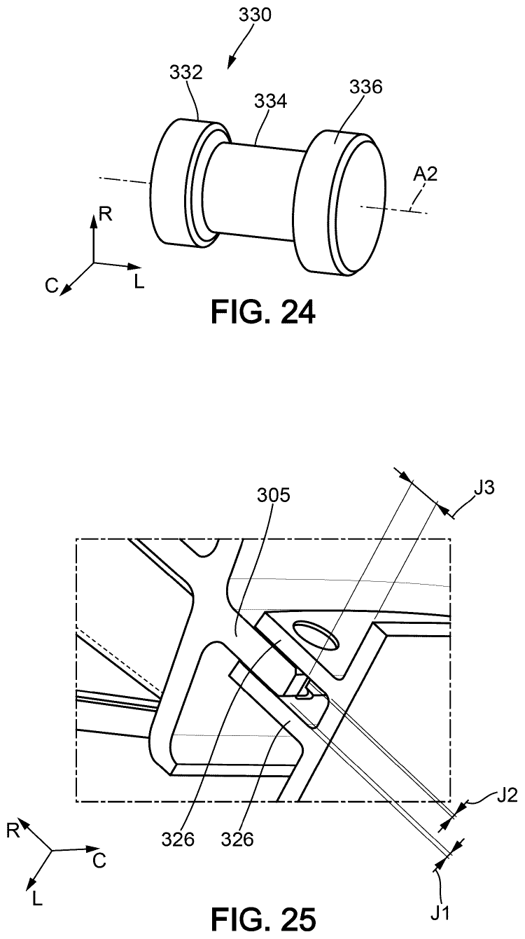

As shown in FIG. 34A, the radially outer annular wall 502 is fixed in a seal support 505. Each radially outer annular wall segment 502 carries a coupling member 506 circumferentially engaged and radially retained in a circumferential groove of the seal support 505. The coupling member 506 has a dovetail shape extending circumferentially. The seal support 505 comprises an upstream wall 507 extending radially inwardly and formed facing the upstream face of the hydrostatic annular seal 501 so as to contribute to the sealing of the elastically deformable member 504. The annular part 505 includes an upstream annular leg 508 and a downstream annular leg 509. The upstream annular leg 508 and the downstream annular leg 509 have a U-shape capable of sliding radially on a radial annular partition wall of an annular row of stator vanes as shown in FIG. 21. The radial annular partition wall may include oblong or rectangular openings opening radially inwards and into which fastening means passing through the upstream and downstream legs of the seal support 505 are engaged. The fastening means may comprise pins as described with reference to FIGS. 24 and 25.

FIG. 34B shows the presence of a locking member for the radially outer annular wall segment on the seal support 505. Locking is achieved here by a pin 513 interference-fitted through the support and the coupling member 506 of the seal 501.

As shown in FIG. 35A, the seal support may be a 360° part which includes a lateral opening 509 opening into the interior of the circumferential groove of the seal support. Thus, the circumferential groove is made accessible to allow mounting by longitudinal translation of each seal in the lateral opening then by rotation.

The annular seal could be of any type. For example, it may be of the type described with reference to FIG. 9 and comprise two radially inner annular wall segments 510a, 510b each formed monolithically with a radial leg 515. Each radial leg 515 is connected to the same leg 514 arranged circumferentially between the two legs 515. Further details of the seal can be seen in FIG. 9. The seal support 505 and seal 401 coupling can be produced with other seals in this document such as the seal described with reference to FIGS. 10 to 15.

After assembly of all seal segments, an annular flange 519 is mounted on the downstream face of the seal in order to block the lateral opening. The flange thus comprises protrusions 517 bolted to the seal support 505.

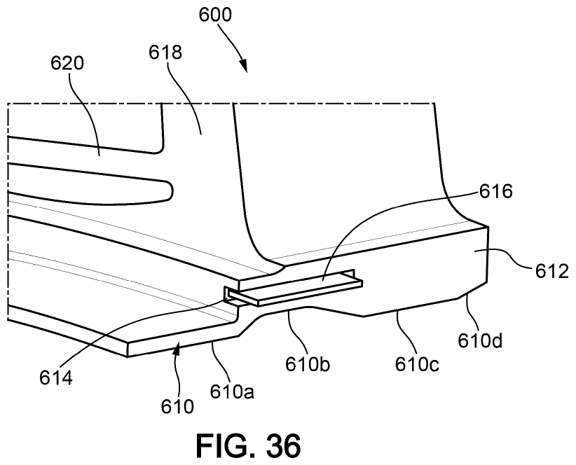

FIG. 36 shows a particular embodiment of a hydrostatic annular seal 600.

As described above, a hydrostatic annular seal 600 comprises a radially inner annular wall and a radially outer annular wall between which elastically deformable members are formed. This description in relation to FIG. 36 is applicable to any one of the annular seals described with reference to the figures. The elastically deformable seal could be of the type described with reference to FIG. 9, or one of FIGS. 10 to 15. In FIG. 36, a radial leg 618 and an elastically deformable strip 620 is shown.

The radially inner annular wall is segmented and comprises a plurality of segments 610 arranged circumferentially end-to-end. Each segment 610 comprises a first circumferential edge 612 and a second circumferential edge (not shown) circumferentially opposite the first edge 612. The first circumferential edge 612 of a segment 610 is circumferentially placed end-to-end with a second circumferential edge of a circumferentially adjacent segment 610.

As shown in FIG. 36 in relation to a first circumferential edge 612 of a segment 610, a slit 614 is formed in the thickness of the segment 610 and in the first circumferential edge 612 thereof. This slit 614 opens out circumferentially and may have a substantially rectangular cross-sectional shape. The same slit 614 is formed in the second circumferential edge of each shoe segment.

According to this document, a tongue 616 is partially mounted in a slit 614 of a first circumferential edge 612 and in a circumferentially facing slit 614 of a second circumferential edge of a circumferentially adjacent shoe 610.

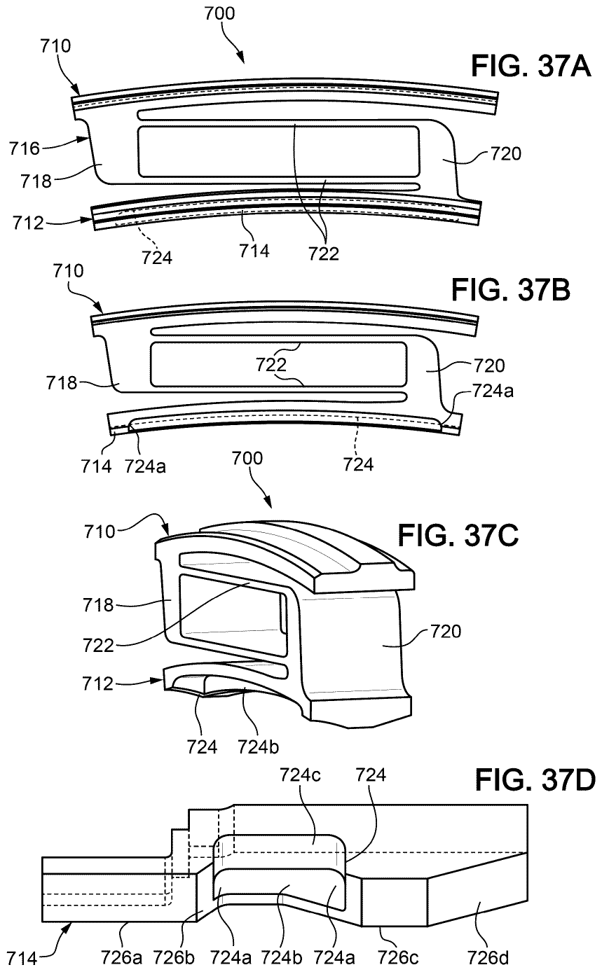

As described with reference to FIG. 36, each inner segment 610 may comprise a radially inner surface including a first substantially cylindrical surface part 610a, a second surface part 610b formed by a recess, a third substantially cylindrical surface part 610c and preferably a fourth frustoconical surface part 610d with a cross-section increasing towards the downstream. The recess extends from one circumferential end to the other of the segment 610 and has a concave curved shape which can be formed by a longitudinal succession of flat surfaces. A housing as mentioned in FIGS. 37A, 37B, 37C and 37D could also be formed in the recess.

It is observed that the slit 614 is formed substantially radially outside the recess so that a plane perpendicular to the longitudinal axis intercepts both the slit 614 and the recess.

In one particular embodiment, the slit extends up to the third part 610c. The slit is open circumferentially and axially upstream. The upstream opening is sealed by a sealing piece (not shown) which prevents air flow at the upstream opening. The seal as described with reference to FIGS. 5 to 7 may be used.

Reference is now made to FIGS. 37A, 37B, 37C and 37D showing a hydrostatic annular seal 700 comprising a radially outer annular wall 710 and a radially inner annular wall 712 which is segmented and formed by a plurality of segments 714 arranged circumferentially end-to-end. Elastically deformable members 716 are arranged radially between the inner 712 and outer 710 walls. This seal 700 may be mounted at the radially inner end of an annular row of stator vanes of a turbine machine. It could be mounted at any other location where it could have the same function, for example at a radially outer end of an annular row of stator vanes or at the interface between any rotating and fixed part in a turbine engine.

As can be seen, the segment shown in FIGS. 37A, 37B, 37C and 37D has the same shape as the segment shown in FIG. 8. However, what is described hereinafter with reference to FIGS. 37A, 37B, 37C and 37D is also applicable to the other seals in this document, in particular to the seal as shown in FIGS. 9 to 12.

Each elastically deformable member 716 may comprise two substantially radial legs 718, 720, a first 720 of which is connected to the segment 714 and a second 718 of which is connected to the outer annular wall 710. The two legs 718, 720 are connected to each other by elastic strips 722.

It is here proposed to form a housing 724 on the radially inner face of each segment 714, this housing 724 opening radially inwards, this housing 724 having upstream and downstream faces 724a, and circumferential faces 724b formed in the thickness of the segment 714. The housing also comprises a bottom wall 724c connecting the radially outer ends of the circumferential 724b, upstream and downstream 724a walls. FIGS. 37A, 37B, 37C and 37D represent different orientations of the seal and cross-sections for FIG. 37B, FIG. 37C, and FIG. 37D.

It can be observed that the housing 724 may have a substantially parallelepiped shape, i.e. whose lateral or circumferential 724b, upstream and downstream 714a and bottom 724c walls are substantially flat, disregarding the connecting radii between said walls. The housing 724 may be substantially circumferentially centered on the circumferential extent of the segment 714.

The housing 724 thus produced does not open circumferentially or longitudinally since the circumferential faces 724b facing each other and the upstream and downstream faces 724a facing each other are formed in the thickness of the segment 714.

The housing 724 may extend circumferentially over a distance less than 80% of the circumferential extent of the segment. In addition, the housing 724 may extend longitudinally over a distance less than 50% of the longitudinal extent of the segment 714.

In one particular embodiment of the seal 700, each housing 724 has a depth of at least 50% of the maximum radial dimension of the segment 714.

FIG. 37D shows that the radially inner surface of the segment 714 comprises a first substantially cylindrical surface part 726a, a second surface part 716b forming a recess, a third substantially cylindrical surface part 726c and a fourth frustoconical surface part 726d with a cross-section increasing towards the downstream.

According to this document, the housing 724 is formed in the annular recess 726b. The recess 726 may have a concave curved shape. Here, it is composed of a succession of conical surfaces.

The elastic members 716 could have the shape of those described with reference to FIGS. 9 to 12. In this case, the primary and secondary segments are each provided with a housing 724 formed in the thickness thereof. For the remainder of the characteristics relating to the elastic member, reference will be made to the description made with reference to FIGS. 9 to 12.

The integration of a housing 724 as described with reference to FIGS. 37A, 37B, 37C and 37D could be carried out on any one of the annular seals and assembly described in this document.

The annular seal 700 could also comprise slits formed in the circumferential edges of each segment for receiving a sealing tongue as described with reference to FIG. 36.

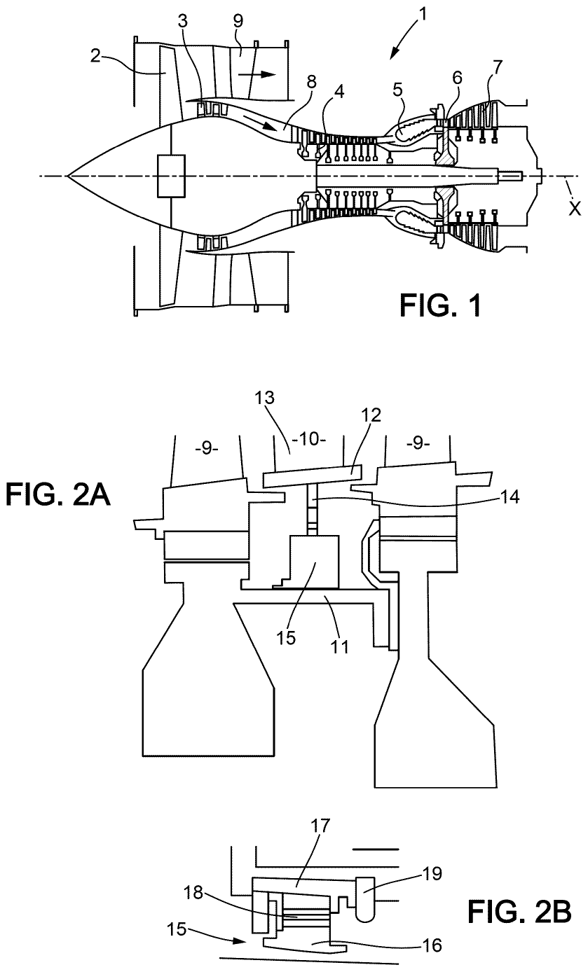

Reference is now made to FIG. 38 schematically showing a partial view of an assembly 800 for a turbine engine with a longitudinal axis according to this document. Preferably, such an assembly is used in a turbine, in particular a low-pressure turbine, of a turbine engine as described above with reference to FIG. 1. This document also relates to any type of turbine engine comprising such a turbine, for example a turboprop or turbojet for an aircraft.

The assembly 800 comprises a cylindrical shroud 811 intended to be rotated about the longitudinal axis and an annular row of stator vanes 820. The assembly 800 may also include two annular rows of moving blades 810 arranged longitudinally on either side of the annular row of stator vanes 820 and connected to each other by the cylindrical shroud 811. The annular row of stator vanes 820 carries a hydrostatic annular seal 822 arranged radially inside the annular row of stator vanes 820 and radially outside the cylindrical shroud 811, the hydrostatic annular seal 822 cooperating in a non-contact sealing manner with the cylindrical shroud 811.

In addition, the cylindrical shroud 811 comprises an annular layer 812 facing the hydrostatic annular seal 822 which is made of a first material having a hardness greater than a hardness of a material of a radially inner end 823 of the hydrostatic annular seal 822 facing the annular layer 812.

The use of a harder material for the annular layer improves the mechanical strength of the cylindrical shroud relative to the hydrostatic annular seal. Thus, in the event of rotor eccentricity following a sudden maneuver or a failure, such an assembly mechanically protects the cylindrical shroud in the event of prolonged contact between the hydrostatic annular seal and the cylindrical shroud. The mechanical integrity of the cylindrical shroud can thus be preserved.

In particular, the cylindrical shroud 811 has a circular cross-section with a constant radius along the longitudinal axis over at least one longitudinal portion of the cylindrical shroud. This shape provides better control of the clearance between the hydrostatic annular seal and the cylindrical shroud. In particular, the cylindrical shroud 811 is devoid of lips.

The hydrostatic annular seal preferably comprises a radially outer annular wall, a radially inner annular wall and a plurality of elastically deformable members, in particular distributed circumferentially about the longitudinal axis. Each of the plurality of elastically deformable members includes a first substantially radial leg connected to the radially outer annular wall, a second substantially radial leg connected to the radially inner annular wall and at least one elastically deformable strip extending circumferentially. Said at least one strip is connected to the first leg at a circumferential end and to the second leg at an opposite circumferential end. In other words, the first leg performs the connection between one of the circumferential ends of said at least one strip and the radially outer annular wall, and the second leg performs the connection between the other of the circumferential ends of said at least one strip and the radially inner annular wall. The hydrostatic annular seal can thus deform radially thanks to the flexibility provided by said at least one strip connecting together the radially inner annular wall and the radially outer annular wall. The radially inner and outer annular walls, the legs and the strips are in particular dimensioned to control the radial deformation of the hydrostatic annular seal, and therefore control a clearance between the hydrostatic annular seal and the cylindrical shroud. Such a deformable member is shown in FIG. 8.

The elastically deformable member could also be of the type described with reference to FIGS. 9 to 12.

The first material must then be harder than the material of the shoe.

The shoe composed of a material having a higher abradability than that of the coating of the shroud, ensures that wear during contact between the shroud and the shoe of the hydrostatic seal occurs only on the shoe and not on the shroud.

The shoe may in particular have an aeraulic shape. By means of negative pressure and positive pressure on either side of the shoe, this increases a clearance between the cylindrical shroud and the hydrostatic annular seal as they move towards each other and, conversely, reduces the clearance between the cylindrical shroud and the hydrostatic annular seal as they move away from each other.

The hydrostatic annular seal is preferably made of a metallic material.

The first material may also have an abrasion resistance greater than the abrasion resistance of the material of the radially inner end 823 of the hydrostatic annular seal 822 facing the annular layer 812.

A part 814 of the cylindrical shroud 811 extending longitudinally from one to the other of the two annular rows of moving blades 810 is in particular made of a first material having a hardness greater than the hardness of the second material. In other words, the part 814 of the cylindrical shroud 811 made of the second material connects the two annular rows of moving blades. The second material can in particular be adapted to ensure the mechanical transmission of torque between the two annular rows of moving blades 810.

The second material may have an abrasion resistance lower than the abrasion resistance of the first material.

The second material may in particular be a steel, a nickel-based alloy or a cobalt-based alloy.

The first material and the second material have in particular mechanical strength and temperature resistance characteristics consistent with the thermomechanical operating conditions of the turbine engine.

The annular layer 812 may have a longitudinal dimension L1 greater than a longitudinal dimension L2 of the hydrostatic annular seal 822 along the longitudinal axis X. Such a feature ensures that the hydrostatic annular seal 822 can be radially facing the annular layer 812 even in the event of relative longitudinal movement between the cylindrical shroud 811 and the annular row of stator vanes 820. This relative longitudinal movement is commonly referred to as longitudinal sliding. Longitudinal sliding may occur in different operating phases of the turbine engine.

With reference to FIG. 39, the cylindrical shroud 811 may have an annular recess 813 intended to receive the annular layer 812. In particular, the annular recess 813 and the annular layer 812 can have the same thickness. In other words, the annular layer 812 may not add additional thickness to the cylindrical shroud 811.

With reference to FIG. 40, the annular layer 812 may form a protrusion relative to a first radially outer surface 815 of the cylindrical shroud 811. The first radially outer surface 815 of the cylindrical shroud 811 may in particular correspond to a surface most radially inside a radially outer periphery of the cylindrical shroud 811. For example, the annular layer 812 can form a ring, i.e. extend over 360°. The layer could be partially housed in the shroud and partially formed protruding with respect to the outer surface of the shroud.

The annular layer 812 may have a radial thickness h so as to provide sufficient mechanical strength to the annular layer in the event of contact between the cylindrical shroud and the hydrostatic annular seal.

According to another aspect, a method for manufacturing the assembly 100 as described above is described. The method comprising the following steps:
placing the annular layer 812 on the cylindrical shroud 811,
machining a radially outer face 816 of the annular layer 812.

The method then ensures that the annular layer 812 complies with the dimensional constraints, geometric tolerances, and surface condition of the cylindrical shroud 811.

Reference is now made to FIG. 41 schematically showing a partial cross-section of an assembly 900 for a turbine engine with a longitudinal axis according to this document, and two enlarged views of the assembly. Preferably, such an assembly is used in a turbine, in particular a low-pressure turbine, of a turbine engine as described above with reference to FIG. 1. This document also relates to any type of turbine engine comprising such a turbine, for example a turboprop or turbojet for an aircraft.

The assembly 900 comprises a shroud 931 intended to be rotated about the longitudinal axis X and a stator stage 920 extending about the longitudinal axis X and radially outside the shroud 931. The shroud 931 may in particular have a cylindrical shape, at least over a longitudinal portion of the shroud. The shroud 931 is in particular devoid of lips. The assembly 900 may also comprise two annular rows of moving blades 930 intended to be rotated about the longitudinal axis X, the two annular rows of moving blades 930 being arranged longitudinally on either side of the annular row of stator vanes 920 and connected to each other by the shroud 931.

The stator stage 920 includes an annular row of stator vanes 921. More specifically, the annular row of stator vanes 921 comprises a radially outer annular platform and a radially inner annular platform 922 between which a plurality of vanes extend. The annular row of stator vanes 921 includes a radial partition wall 923 which extends radially inwardly from the radially inner annular platform 922.

The stator assembly 920 also comprises a hydrostatic annular seal 950 carried by the annular row of stator vanes 921 and radially facing the shroud 931, the hydrostatic annular seal 950 being configured to cooperate in a non-contact sealing manner with the shroud 931.

In addition, the stator stage 920 and more specifically the annular seal comprises an abutment system capable of coming into direct or indirect abutment with the shroud 931 and limiting the radial displacement of the seal.

In the context of an overspeed start of a turbine rotor comprising the shroud, the hydrostatic annular seal may come into contact with the shroud, under the effect of radial expansion of the latter at overspeed. The abutment system advantageously makes it possible to reinforce the contact between the stator stage 920 and the shroud 931 to help brake the rotor in the event of overspeed. Such an assembly 910 thus makes it possible to passively brake the rotor. The assembly thus protects the mechanical integrity of the rotor in the event of overspeed.

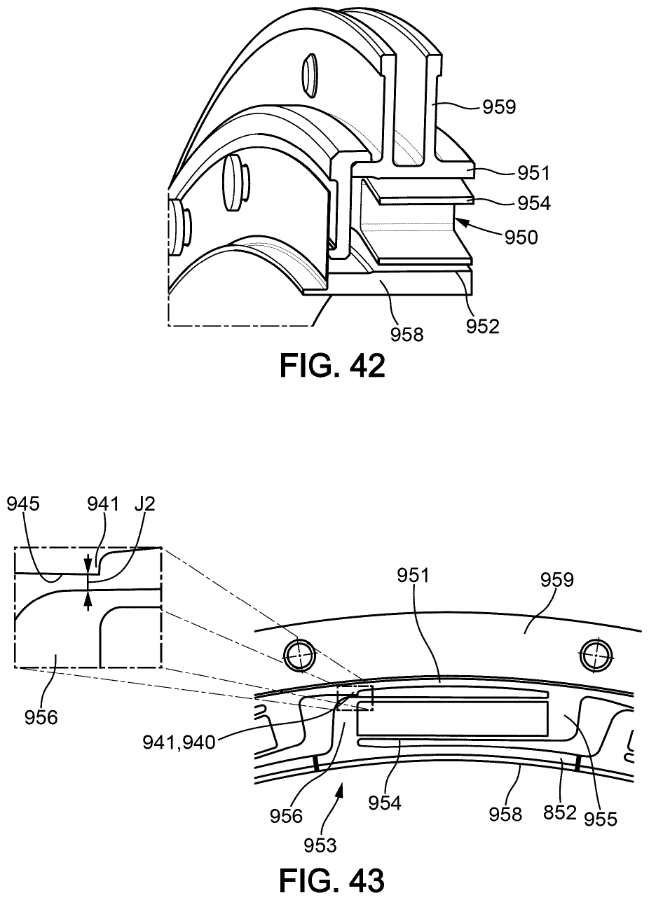

More specifically, with reference to FIG. 42, the hydrostatic annular seal 950 comprises a radially outer annular wall 951, a radially inner annular wall 952 and a plurality of elastically deformable members, in particular distributed circumferentially about the longitudinal axis. The hydrostatic annular seal 950 preferably includes a ring 959 extending radially outwards from the radially outer annular wall 951. For example, the ring may have a U-section, the two arms of the U being arranged on either side of the radial partition wall. The two arms of the U and the radial partition wall can be positioned by means of centering pins.

The radially inner annular wall 952 and the radially outer annular wall 951 may in particular be formed respectively from a plurality of inner wall segments arranged circumferentially end-to-end and a plurality of outer wall segments arranged circumferentially end-to-end. Each of the inner wall and outer wall segments is in particular connected to an elastically deformable member of the plurality of elastically deformable members.

With reference to FIGS. 43, 44 and 45, each of the plurality of elastically deformable members 953 includes a first substantially radial leg 955 connected to the radially outer annular wall 951, a second substantially radial leg 956 connected to the radially inner annular wall 952 and at least one elastically deformable strip 954 extending circumferentially. As such, only the strips 954 are able to deform, the legs 955, 956 are non-deformable.

Said at least one strip 954 is connected to the first leg 955 at a circumferential end and to the second leg 956 at an opposite circumferential end. In other words, the first leg 955 performs the connection between one of the circumferential ends of said at least one strip 954 and the radially outer annular wall 951, and the second leg 956 performs the connection between the other of the circumferential ends of said at least one strip 954 and the radially inner annular wall 952. The hydrostatic annular seal can thus deform radially thanks to the flexibility provided by said at least one strip connecting together the radially inner annular wall and the radially outer annular wall.

The radially inner and outer annular walls, the legs and the strips are in particular dimensioned to control the radial deformation of the hydrostatic annular seal, and therefore control a clearance between the hydrostatic annular seal and the shroud. A first clearance J1 (shown in FIG. 41) is defined between the hydrostatic annular seal 950 and the shroud 931, corresponding to a nominal clearance in operation between the hydrostatic annular seal and the shroud. Alternatively, the first clearance can be defined as a cold clearance of the turbine.

More precisely, the first leg 955 comprises a radially outer end directly connected to a radially inner face of the radially outer annular wall and a radially inner end which is devoid of a direct connection to the radially inner annular wall. Similarly, the second leg 956 comprises a radially inner end directly connected to a radially outer face of the radially inner annular wall and a radially outer end which is devoid of a direct connection to the radially outer annular wall.

In addition, the first leg 955 and the second leg 956 are in particular adapted to not deform radially. Only the leg 956 is capable of moving radially with the radially inner annular wall and towards (or away from) the radially outer annular wall.

Each of the plurality of elastically deformable members 953 can in particular include a plurality of radially spaced strips 954, for example two strips. In particular, the strips are substantially parallel to one another.

The radially inner annular wall may support an abradable shoe 958 arranged radially facing the shroud 931 and capable of wearing in the event of contact with the shroud 931.

The abradable shoe 958 may in particular have an aeraulic shape. By means of negative pressure and positive pressure on either side of the shoe, this increases a clearance between the shroud and the hydrostatic annular seal as they move towards each other and, conversely, reduces the clearance between the shroud and the hydrostatic annular seal as they move away from each other.

With reference to FIG. 43 schematically showing an exemplary embodiment of the assembly according to this document, the abutment system 940 comprises at least one first radial abutment element 941 carried by the radially outer annular wall 951 radially facing the second leg 956 of one of the plurality of elastically deformable members 953. Thus, the first radial abutment element can abut against the second leg. The abutment elements are in this case radial protrusions.

Said at least first radial abutment element 941 may also be supported by the radially inner annular wall 952 radially facing the first leg 955 of one of the plurality of elastically deformable members 953. Thus, the first radial abutment element can abut against the first leg.

Said at least first radial abutment element 941 may also be supported by the second leg 956 of one of the plurality of elastically deformable members 953 radially facing the radially outer annular wall 951, or supported by the first leg 955 of one of the plurality of elastically deformable members 953 radially facing the radially inner annular wall 952. Thus, the first radial abutment element 941 can abut against the radially inner annular wall when it is supported by the first leg, or against the radially outer annular wall when it is supported by the second leg.

The abutment system 940 may also comprise at least two first radial abutment elements 941, one being supported by the second leg 956 radially facing the radially outer annular wall 951 or vice versa, and the other being supported by the first leg 955 radially facing the radially inner annular wall 952 or vice versa.

Said at least one first radial abutment element 941 allows to reinforce the radial contact between the hydrostatic annular seal and the shroud, and thus to improve braking of the shroud in the event of overspeed. Moreover, the first radial abutment element is then advantageously directly integrated into the hydrostatic annular seal, which makes it easier to implement from the point of view of manufacturing the assembly. In particular, the first radial abutment element 941 may be formed integrally with the hydrostatic annular seal.

The first radial abutment element 941 may form a radial protrusion.

The first radial abutment element 941 may have a first abutment surface 945 substantially parallel to a face against which the first abutment surface is able to abut.

As shown in FIG. 43, a second clearance J2 between the first abutment surface 945 and the face against which the first abutment surface is able to abut, must be less than or equal to the first clearance J1. As shown in FIG. 43, a second clearance J2 between the first abutment surface 945 and the face against which the first abutment surface is able to abut may be 0.2 mm or more. Thus, when the shroud deforms radially outwardly under the effect of overspeed, the radially outward movement of the radially inner annular wall of the seal is limited, which ensures contact between this wall and the shroud 931.

The first radial abutment element 941 may extend over part or over the entire longitudinal dimension of the hydrostatic annular seal 950.

In particular, the abutment system 940 preferably comprises a plurality of first radial abutment elements 941. For example, each of the plurality of elastically deformable members may comprise one of the plurality of first radial abutment elements 941.

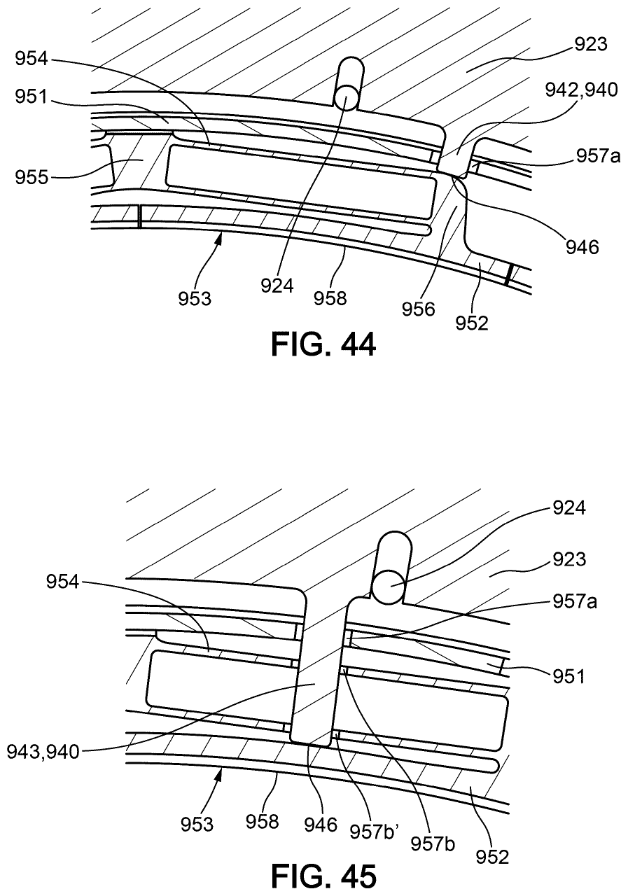

FIGS. 44 and 45 show exemplary embodiments of the assembly according to this document. The assembly may comprise at least one second radial abutment element 942, 943 forming a finger extending radially inwardly from the annular row of stator vanes. Said at least one second radial abutment element 942, 943 is able to abut radially against the radially inner annular wall 952 (as shown in FIG. 45) and/or against the second leg 956 of one of the plurality of elastically deformable members 953 (as shown in FIG. 44).

The second radial abutment element 942, 943 may be connected to the radial partition wall 923 at a first end. The second radial abutment element 942, 943 may comprise a second end opposite the first end facing the radially outer face of the radially inner annular wall 952 or the radially outer end of the second leg 956 of one of the plurality of elastically deformable members.

The second radial abutment element 942, 943 may in particular extend over a part of or over the entire longitudinal dimension of the radial partition wall 923.

The second radial abutment element may radially pass through at least one opening 957a, 957b, 957b′ arranged in the hydrostatic annular seal.

With reference to FIG. 44, the second radial abutment element 942 is able to abut radially against the second leg 956. A first opening 957a is in particular arranged in the radially outer annular wall 951, the first opening 957a facing the radially outer end of the second leg 56. Thus, the second radial abutment element 942 passes through the first opening 957a.

With reference to FIG. 45, the second radial abutment element 943 is capable of abutting radially against the radially inner annular wall 952, in particular against the radially outer face of the radially inner annular wall 952. The second radial abutment element 943 passes through a first opening 957a arranged in the radially outer annular wall 951, and a second opening 957b, 957b′ arranged in each strip of said at least one strip 954. The second radial stop element 943 may in particular be circumferentially positioned between the first leg 955 and the second leg 956, in particular substantially in the middle of the first leg 955 and the second leg 956.

The second radial abutment element 942, 943 may have a second abutment surface 946 substantially parallel to a face against which the second abutment surface is able to abut.

A third clearance between the second abutment surface and the face against which the second abutment surface is able to abut, may preferably be of the same order of magnitude as the first clearance. This technical feature ensures that, when the shroud extends radially under the effect of overspeed, and then the hydrostatic annular seal and the shroud come into contact, the hydrostatic annular seal cannot deform radially enough to allow a flow of gas to pass between the hydrostatic annular seal and the shroud.

The assembly may comprise a plurality of second radial abutment elements 942, 943. For example, each of the plurality of elastically deformable members may comprise one of the plurality of second radial abutment elements.

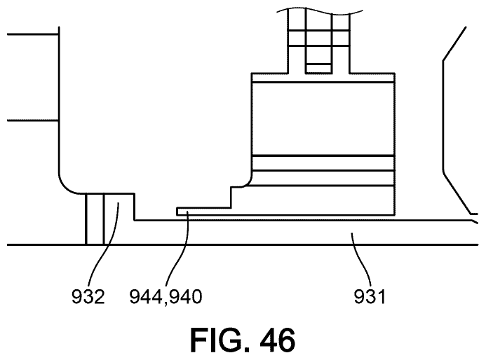

With reference to FIG. 46, at least one third longitudinal abutment element 944 of the abutment system 940 may advantageously extend longitudinally from the hydrostatic annular seal 950. Said at least third longitudinal abutment element 944 is able to abut longitudinally against a radial portion 932 of the annular shroud 931 longitudinally facing. Such a feature ensures contact between the shroud and the hydrostatic annular seal in the event of relative longitudinal movement between the shroud and the stator stage, and in particular in the event of breakage of the rotor shaft. Thus, said at least one third longitudinal abutment element may advantageously help brake the rotor in the event of overspeed.

Said at least one third longitudinal abutment element 944 may preferably have an annular shape.

The abutment elements have been presented individually in a non-limiting manner in the preceding description, the assembly being able to comprise a combination of said at least one first radial abutment element, said at least one second radial abutment element and said at least one third longitudinal abutment element.

1. A seal for an aircraft turbine engine, the seal comprising a plurality of seal segments that are circumferentially distributed about a longitudinal axis, each seal segment comprising:
a radially outer annular wall segment;
a radially inner annular wall segment, the radially outer and radially inner wall segments connected to each other by an elastically deformable member, the radially outer annular wall segments forming a monolithic outer shroud, the radially inner annular wall segments arranged circumferentially end-to-end, each radially inner annular wall segment comprising a first circumferential edge and an opposite second circumferential edge which each have a slit; and
a tongue mounted in part in the slit of the first circumferential edge (612) of one radially inner annular wall segment (610) and in part in a circumferentially opposite slit of the second circumferential edge of a circumferentially adjacent radially inner annular wall segment.

2. The seal according to claim 1, wherein each slit has a radial dimension between 0.5 and 1.2 mm, preferably about 0.8 mm.

3. The seal according to claim 1, wherein each tongue has a longitudinal dimension less than a circumferential dimension, a radial dimension being less than the longitudinal dimension.

4. The seal according to claim 1, wherein the tongues are arranged between an upstream end and a longitudinal median plane of the radially inner annular wall segment.

5. The seal according to claim 1, wherein the tongues have a substantially rectangular shape.

6. An assembly comprising
a cylindrical rotor shroud having a longitudinal axis and a distributor which has a stator vane ring, the distributor including a foot (403) at a radially inner end of the distributor; and
a seal according to claim 1 being mounted on the foot (403) of the distributor, and the seal cooperating in a non-contact sealing manner with the cylindrical rotor shroud of the turbine engine arranged radially under the distributor.

7. A turbine for an aircraft turbine engine, the turbine comprising:
a casing,
the assembly according to claim 8; and
a rotor which comprises a cylindrical shroud rotated about the longitudinal axis and the distributor being mounted in the casing and the cylindrical shroud being arranged radially under the distributor.

8. A turbine engine comprising the assembly according to claim 6.

9. A turbine engine comprising the turbine according to claim 7.
